(19) United States
(12) Patent Application Publication
(10) Pub. No.: US 2024/0238824 A1
(43) Pub. Date: Jul. 18, 2024

(54) PAINTING PLANTS WITH OVERSPRAY REMOVAL SYSTEMS

(71) Applicant: GEICO S.p.A., Cinisello Balsamo (MI) (IT)

(72) Inventor: Valerio IGLIO, Cinisello Balsamo (MI) (IT)

(21) Appl. No.: 18/561,859

(22) PCT Filed: Jun. 16, 2022
(86) PCT No.: PCT/IB2022/055575

§ 371 Date: Nov. 17, 2023

(30) Foreign Application Priority Data
Jun. 17, 2021 (IT) 102021000015884

(51) Int. Cl. B05B 15/555; B05B 13/04; B05B 14/41; B08B 3/04; B08B 3/12; B08B 3/14

(52) U.S. Cl. CPC B05B 15/555; B05B 13/0431; B05B 14/41; B08B 3/042; B08B 3/123; B08B 3/14

(57) ABSTRACT

A painting plant may include: a painting booth; at least one overspray removal unit; a cleaning unit; and a conveyor. The painting plant may be further configured so that an air stream, when exiting the painting booth, passes through the at least one overspray removal unit. The at least one overspray removal unit may include a purification chamber configured to contain cleaning elements. The purification chamber may include an inlet for the air stream with the overspray, an outlet for the air stream after the air stream has passed through at least part of the cleaning elements, and a discharge outlet. The discharge outlet may be configured to discharge at least a portion of the cleaning elements from the purification chamber to the cleaning unit. The conveyor may be configured to transport at least a portion of the cleaning elements from the cleaning unit back to the purification chamber.

The present invention relates to a plant of the type used for performing painting (in particular painting of motor vehicle body parts) using atomized paint.

In the technical sector of spray-painting the problem of so-called “overspray”, namely the atomized paint which is not deposited on the parts to be sprayed and which must therefore be removed from the painting booth, is well-known. The removal of the overspray is usually performed by means of a suitable air stream which crosses the booth.

The air stream evacuated from the booth must, however, be cleaned of the paint before it can be released into the environment or introduced again into the booth. For this purpose various systems for separating the overspray from the air extracted from the booth have been proposed. For example, known systems of the electrostatic type, for performing removal using a film of water, with filters for filtering the liquid particles, are known. These systems are generally complex and require a high degree of maintenance owing to the adhesive nature of the paint.

Powder inerting systems have also been proposed, i.e. systems in which the air stream is conveyed across a filtering system composed of a chamber inside which a suitable powder inerting product (for example calcium carbonate) is blown, said product absorbing the particles of paint and being then intercepted by normal dust filters. Such a system is described for example in US20130122188.

This system requires, however, a relatively large quantity of powder which must then disposed of, with high disposal costs. The procurement of the powders is not always easy and may be costly. Moreover, relatively complex techniques are necessary for moving the powder, blowing it in a uniform manner inside the chamber, intercepting it and evacuating it effectively from the air stream after absorption of the paint, moreover preventing the paint-soiled powder from soiling and clogging the filters used to separate it from the air stream conveying it. The said filters are costly and require relatively frequent maintenance in order to prevent them from becoming completely blocked up.

Moreover, the substantially random distribution of the powder inside the chamber may not be sufficient to prevent the paint from adhering to the walls of the chamber and to eliminate securely all the overspray. Also attempts to provide a greater concentration of powder along the path of the air stream have proved to be not entirely satisfactory.

Systems have also been proposed where the air stream containing the overspray is made to pass through a mass of small solid elements with a shape (for example spherical, cylindrical or saddle shape) leaving free spaces through which the air may flow, while the overspray adheres to the surface of these solid elements. The solid elements may also be stirred with suitable mechanical devices so as to prevent the paint which adheres to them from causing them to stick to each other, forming agglomerates which in the end prevent the passage of the air and which are difficult to handle.

In any case, after the solid elements have collected a certain amount of overspray it becomes necessary to stop the plant, remove the solid elements and replace them with clean elements. The operation may however result in relatively long stoppage of the plant and also the need to transport and handle the mass of solid elements, with risks for the operators and the danger of paint being spread and soiling other parts of the plant. Moreover large quantities of solid elements may be required in order to be able to replace in the plant all the soiled elements with clean elements, while the soiled elements are eliminated or cleaned.

In the case where the elements are to be cleaned rather than eliminated, the cleaning operation is not simple. If solvents are used, the time required to remove them from the plant and transport them to the cleaning locations may also result in excessive drying of the paint deposited on the elements to be cleaned, with the need for a longer cleaning time and the need for larger quantities of suitable solvents. The use of large quantities of solvents also gives rise to further problems in terms of management, disposal and potential pollution. The major difficulties associated with cleaning may also be such that it is preferred to destroy completely the soiled elements, but this gives rise to further pollution problems and costs.

The soiled elements may also result in the removal and transport systems becoming soiled with paint and therefore the need for further cleaning time and the use of additional quantities of cleaning liquids which must then also be disposed of.

It has also been proposed to provide layers of solid cleaning elements which are mechanically cleaned, by means of friction, for example by conveying them into a treatment zone and then, once cleaned, reintroducing them into layer which receives the air stream. Such a system is described in US468378.

Such a system avoids or limits the use of solvents, but requires movement of the elements from and towards the zone where they are passed over by the air stream with overspray. This circulating movement may result in soiling of the transport systems, as well as delays in the cleaning and reintegration of the solid cleaning elements. Moreover, the cleaning elements in U.S. Pat. No. 4,684,378 are not necessarily arranged as a thin layer on a conveyor belt, through which the air which transports the overspray passes. This results, on the one hand, in poor efficiency with regard to removal of the overspray and, on the other hand, irremediable soiling of the conveyor belt, with dirtying of all the parts of the plant which the belt comes into contact with or which are situated below the belt, from where the paint drips. The belt and all the parts soiled by it must therefore in turn be periodically cleaned again with consequent high maintenance costs and long plant downtimes. Moreover with the use of a moving belt conveying the layer of elements to be cleaned it is difficult to maintain a correct circulation of the overspray removal air. The paint in fact rapidly blocks up the holes in the belt and the solid cleaning elements also remain glued to the belt owing to the removed paint. All of this prevents or hinders in a short amount of time the passage of the air across the belt, resulting in even more frequent stoppages and maintenance of the plant, the greater use of solvents and mechanical processes for cleaning the entire plant. This solution therefore results in a high energy consumption for the drying operation and a greater probability of damaging the plant parts and the cleaning elements. Moreover, the time required for cleaning increases. A long cleaning time is also disadvantageous in the case, for example, of a system which operates in a substantially continuous manner. The dust produced by the plant parts which have been soiled by the paint which then dries is also dangerous and difficult to manage. Free volatile dust must also be avoided in painting plants.

The general object of the present invention is to provide a painting plant where there is efficient removal of the overspray. Further objects are those of ensuring less maintenance, relatively low costs in terms of both management and consumable material and fewer problems for disposal of the pollutants.

In view of these objects, the idea which has occurred is to provide, according to the invention, a painting plant comprising a painting booth in which the paint is sprayed and which is crossed by an air stream for the evacuation of overspray from the booth, the air stream exiting the booth passing through at least one overspray removal assembly (17) for removing the overspray from the air stream, characterized in that the removal assembly comprises a purification chamber containing a loose mass of cleaning elements, the purification chamber having an inlet for the air stream with the overspray and an outlet for the air stream after the air stream has passed through at least part of the loose mass of cleaning elements so as to release the overspray onto cleaning elements, the purification chamber comprising a discharge outlet for discharging cleaning elements of the mass of cleaning elements present in the chamber, the discharge outlet being connected to a cleaning unit for cleaning the cleaning elements discharged through the discharge outlet, between the cleaning unit and the purification chamber there being present a conveyor for conveying the cleaning elements from the cleaning unit back into the purification chamber.

A controlled shutter may also be present at the discharge outlet. The shutter may be a partitioning shutter, namely a shutter which discharges at the outlet a predefined quantity of elements at each actuation.

The conveyor may be advantageously a helical screw conveyor or auger which raises the cleaning elements from the mixing chamber and discharges them again onto the mass of cleaning elements inside the release chamber.

In order to illustrate more clearly the innovative principles of the present invention and its advantages compared to the prior art, an example of embodiment applying these principles will be described below with the aid of the accompanying drawings.

In the drawings:

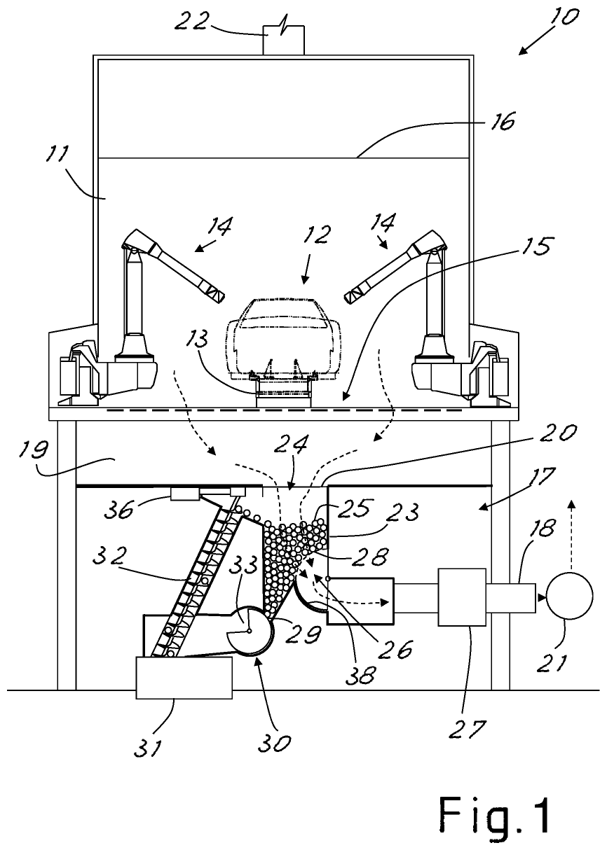

FIG. 1 shows a schematic, cross-sectioned, front view of a painting plant applying the principles of the invention;

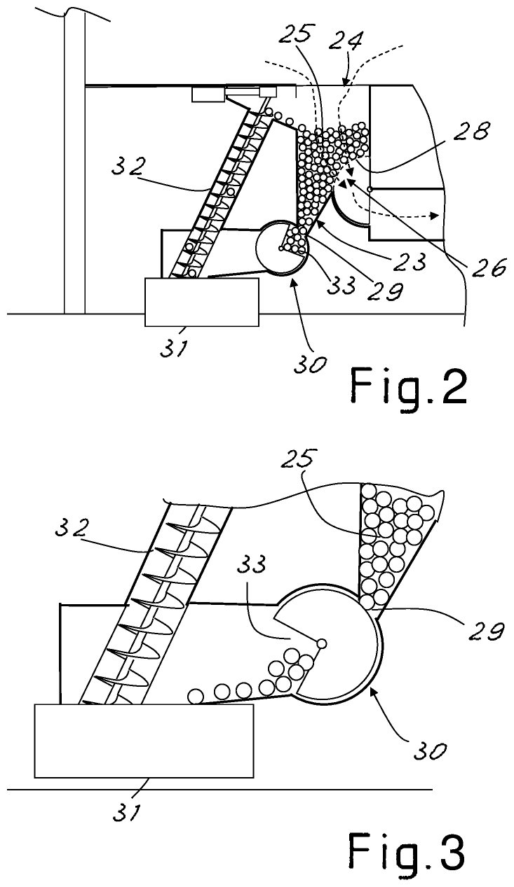

FIG. 2 shows a schematic view on a larger scale of a part of the plant according to FIG. 1 during an operating step;

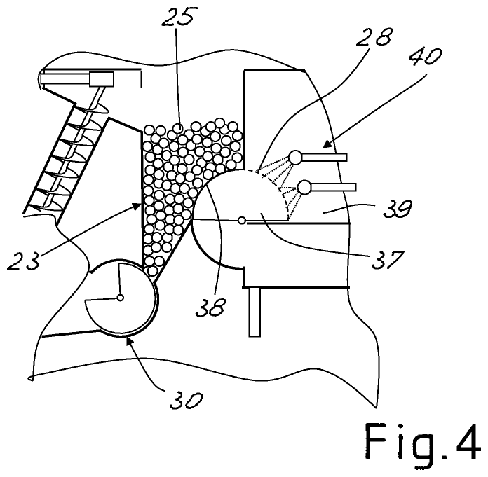

FIGS. 3 and 4 show schematic views, on a further enlarged scale, of further operating steps of the plant according to FIG. 1;

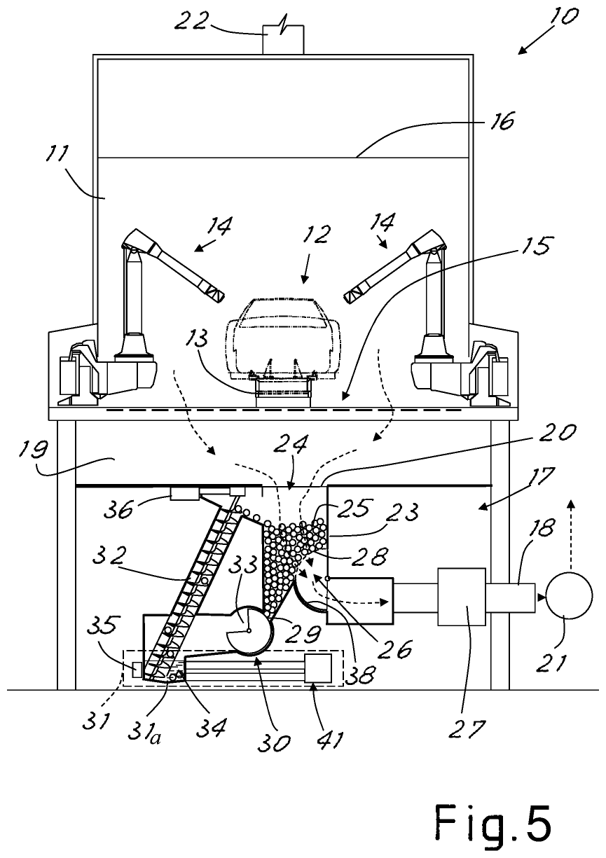

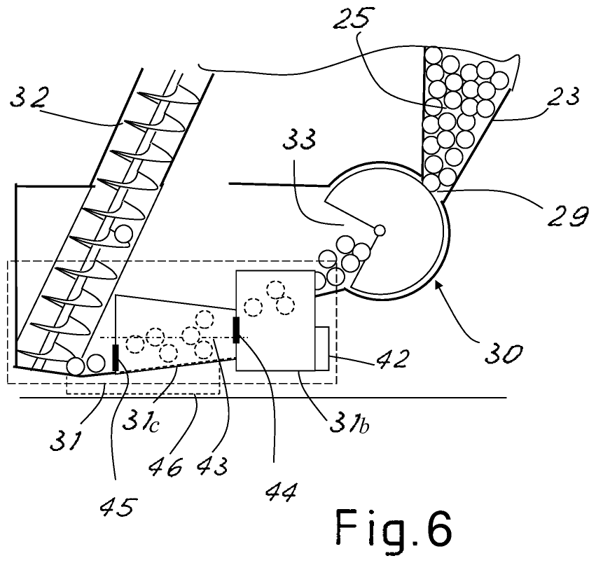

FIGS. 5 and 6 show schematic views of two alternative embodiments of a part of the plant shown in FIG. 1.

With reference to the figures, FIG. 1 shows a painting plant according to the invention, denoted generally by 10.

The plant comprises a booth 11 for painting objects 12 (for example motor vehicle bodies or parts thereof). The objects to be painted are advantageously transported into the booth 11 by means of a known conveyor system 13, for example an intermittent or continuous conveying line.

The chamber 11 is provided with painting devices or painting operator units 14 which spray liquid paint onto the surfaces of the object to be painted. Advantageously, the painting devices may be realized in the form of known robotic arms which are provided with spray guns or cups at their ends.

An air stream is made to pass through the booth 11 in order to remove the overspray from it.

Advantageously, this is obtained by means of a grilled floor 15 of the booth 11 through which the air in the booth may be drawn so as to evacuate the overspray from the chamber. In the ceiling of the booth there are corresponding inlets 16 which are advantageously made with grilles, for the entry of clean air so as to have a continuous air stream which crosses the booth from the top downwards during the painting operations. Other known systems for circulation and extraction of the air from the booth may however be used.

The clean and/or purified air may enter into the booth through one or more ducts 22.

The air stream exiting the booth and containing the overspray is sent to at least one unit 17 for removing the overspray, which is realized in accordance with the principles of the present invention and from which the cleaned air flows out through ducts 18. This situation is shown schematically in the Figures by means of broken-line arrows.

The unit 17 may be situated directly underneath the grilled floor of the booth or may be connected to the air stream with overspray by means of suitable conveying ducts or passages.

For the passage of the air from the booth to the unit 17 there may, for example, be provided underneath the floor of the booth an intermediate chamber 19 which receives all the air passing through the floor and which has, connected thereto (advantageously on the bottom), a passage 20 which conveys the air stream with overspray to the at least one overspray removal unit 17.

If necessary the internal wall of the conveying passages may be lined with a known anti-adhesive material or a known removable film, in order to prevent the adhesion of the overspray on the walls of the passages.

Suitable known aspirators or fans 21 may also be present along the air flow path (for example at the clean air outlet after the unit 17) in order to move suitably the air stream through the unit 17.

The air stream, after crossing the overspray removal unit 17 and being cleaned, may be evacuated externally and/or be conveyed back into the booth via the ducts 22.

In accordance with the principles of the invention, the removal unit 17 comprises a purification chamber 23 which receives the air from which the overspray is to be removed. The purification chamber 23 may receive the air stream with the overspray, preferably from above, through an inlet 24.

Inside the purification chamber 23 there is a loose mass of cleaning elements 25.

The air stream containing the overspray is made to pass through at least some of the mass of cleaning elements 25 so as to release the overspray onto elements of the mass before the air stream exits the chamber 23 through an outlet 26 and flows towards the outlet duct 18.

Advantageously, the cleaning elements are piled up in the mass in contact with each other, except for the interstices which are naturally formed between them and through which the air crossing the mass passes.

Advantageously, the dimensions of the cleaning elements are at least 100 times and preferably between 100 and 10,000 times bigger than the size of an average overspray droplet. Preferably, the cleaning elements have at least a greater dimension that is between 500 and 5000 (advantageously, around 1000) times the average size of the overspray droplets. For example, usually the overspray droplets are atomized with an average size of 7-15 microns.

Preferably, the elements 25 of the mass may have a size of around 1 mm or more. For example, the elements 25 may have advantageously a size of between 1 mm and 50 mm, preferably in the region of 30 mm.

For example, the elements 25 may have a generically defined shape (cylindrical, conical, spherical, ovoidal, cube-like, tetrahedral, etc.) or irregular shape. A particularly advantageous shape has been found to be the spheroidal or spherical shape with a diameter of between 1 and 50 mm, and preferably equal to 30 mm. The thickness of the layer of cleaning elements which the air must pass through will be established so as to obtain the desired removal of overspray, keeping the pressure drop within acceptable limits so as not to excessively obstruct the passage of the air. This will also depend on the shape and size chosen for the elements in the mass, which will leave more or less free space between one element and the adjacent element in the loose mass. Owing to the use of a vertically extending chamber 23 it is possible to obtain in a simple manner an adequate desired thickness of the mass of cleaning elements.

The cleaning elements may be made of a material which does not absorb the paint, but which remains coated by it (for example, suitable plastic material, glass, ceramic or metal or a combination thereof). The elements may have a smooth surface or also a rough and/or machined surface with concavity for increasing the surface area compared to their volume and for collecting more paint.

In order to prevent the cleaning elements from coming out of the chamber through the outlet 26 a perforated wall 28 for the passage of the air, having through-holes with a size smaller than the size of the cleaning elements 25, is provided. Preferably, after exiting the purification chamber 23, the air may also cross a known filter unit 27 suitable for filtering dust and/or residual overspray which may still be present in the air. In view of the efficiency of the system according to the invention, the residual overspray which reaches the filters of the filter units 27 is in any case very limited and the need for maintenance of these filters (for example cleaning or replacement) is suitably reduced.

The purification chamber 23 also comprises a discharge outlet 29 for discharging the cleaning elements 25. A shutter 30 may be provided at the discharge outlet 29, operation of said shutter being able to be controlled (for example by means of a suitable electrical actuator, not shown) for discharging a quantity of elements 25 from the purification chamber 23.

Advantageously, the discharge passage 29 may be in a position lower than the air outlet 26 from the chamber so that, during discharging, it is ensured that the cleaning elements 25 which exit from the discharge passage 29 have already been properly exposed to the air steam with the overspray and have therefore accumulated a significant amount of overspray on their surfaces.

The purification chamber 23 may be shaped so that it narrows towards the bottom as far as the discharge outlet 29 and the air outlet with the perforated wall 28 may be in a zone midway along the height of the chamber.

The purification chamber 23 may have a generally triangular cross-section with an angled corner directed downwards in the region of the discharge outlet 29. The purification chamber 23 may be for example in the form of a hopper. The triangular shape may be in general a right-angled triangle with a vertical side and an opposite inclined side provided with the outlet 26. It has been found that this allows an improved recirculation of the elements of the mass 25 inside the purification chamber 23 and at the same time effective removal of the overspray.

The perforated wall 28 may also be at least partly inclined with respect to the horizontal on one side of the purification chamber so as to have a layer of elements 25 situated above it and crossed by the air directed towards the outlet. At least some of the elements of the layer crossed by the air abandon the layer and move sideways towards the bottom of the purification chamber and therefore towards the discharge opening 29 when discharging is performed.

The unit 17 also comprises a unit 31 for cleaning the elements 25 and a conveyor 32 for transporting the elements 25 from the cleaning unit 31 to the top of the purification chamber 23 and discharging them again on top of the elements 25 already inside the chamber 23. The conveyor 32 may have its inlet end inside the unit 31 and outlet end close to the top of the purification chamber 23. The conveyor may discharge the cleaned elements 25 close to the layer which is situated above or close to the perforated wall 28 so that they can introduced again into the air stream with overspray. The conveyor 32 may be advantageously realized as a helical screw conveyor (or auger). A drive motor 36 provides the controlled transportation movement of the conveyor.

The cleaning unit 31 will be designed with dimensions suitable for receiving the predefined quantity of elements 25 discharged by the shutter 30, treating them, and delivering them to the conveyor 32 so as to transport them back into the purification chamber 23.

For example, the shutter 30 may be advantageously a partitioning shutter, namely a shutter which, when operated, picks up, or allows to pass through, a predetermined quantity of elements 25 through the discharge outlet 29, directing them towards the cleaning unit 31. The removed quantity will be established so as to be for example the quantity suitable for being received and adequately treated inside the cleaning unit 31. For example, the shutter 30 may be a cylindrical-shaped rotating shutter with a pick-up sector 33. For example, the pick-up sector may be formed by a missing segment of the rotating cylindrical shutter.

As shown schematically in FIG. 2, with rotation of the shutter 30, the pick-up sector 33 may be brought opposite the discharge passage 29 and thus receive a predetermined quantity of cleaning elements. A further rotation of the shutter 30 then discharges into the cleaning unit 31 said predetermined quantity of elements 25, as shown in FIG. 3. Although the rotating partitioning shutter has been found to be particularly advantageous, also other types of known partitioning shutters 30 may be used. For example, the partitioning shutter 30 may be realized as a known sliding-valve partitioning shutter.

A system for cleaning the perforated wall 28 which retains the elements 25 inside the purification chamber 23 may also be provided in order to prevent the paint collected by the elements from being able with time to block the through-holes for the cleaned air.

For example, the perforated wall 28 may be movably designed so that it can be extracted or displaced between its operating position over the air passage and a cleaning position. For example, the perforated wall may be displaceable into a cleaning zone 39 outside of the purification chamber.

FIG. 4 shows for example a possible embodiment in which the perforated wall 28 forms parts of a peripheral wall of an at least semi-cylindrical element 37.

The perforated wall 28 may move by means of rotation between the two positions.

A further wall 38 may move together with the perforated wall 28 so that, when the perforated wall 28 moves from the operating position to the cleaning position, the further wall 38 takes the place of the perforated wall 28 in the operation position over the outlet from the purification chamber 23.

The two walls 38 and 28 may form part of the semi-cylindrical element 37 such that a simple rotation (for example through 90°) results in replacement of one wall or the other over the outlet 26.

The further wall 38 may not be perforated in order to interrupt momentarily the outflow of the air from the outlet 26 while the perforated wall 28 moves out of the chamber into the cleaning zone 39. During interruption of the air stream, the filters 27 which may be present downstream of the purification chamber 23 may also be replaced or cleaned for example.

Alternatively, the further wall 38 may also be perforated so that, when one of the two walls 19 and 38 is in the operating position, the other wall is in its cleaning position and, vice versa, so that the air stream is not interrupted even during the occasional alternate cleaning of either one of the two perforated walls.

The perforated wall may also be cleaned manually or, advantageously, by means of an automatic system 40. The automatic system 40 may for example comprise jets of suitable cleaning liquid emitted from cleaning nozzles.

After cleaning, the perforated wall is able to return from the cleaning position into its operating position and the air flow across it may thus be resumed.

As may be now easily imagined by the person skilled in the art, the entire unit 17, including where applicable also the cleaning unit and the conveyor 32, may be easily made in a suitably airtight manner so as to prevent load losses or external leakages of the air stream circulating within the plant. In particular, the chamber with the cleaning elements, the tank and the housing of the conveyor may be made essentially as a single container with a single inlet 24 and the outlet 26 for the circulating air.

During operation of the booth, the air stream with the overspray is pushed across the mass of cleaning elements 25 so that the overspray is eliminated from the air stream and is transferred onto the cleaning elements acted on by the air stream.

Some of the cleaning elements 25 inside the chamber are then cyclically discharged through the discharge outlet 29 and conveyed to the cleaning unit 31. With the discharging of the elements, the upper elements are gradually displaced towards the discharge outlet, with the cleaner elements being kept within or brought into the air stream to be cleaned.

The time spent by the cleaning elements 25 inside the cleaning unit 31 will depend on the time needed for suitable cleaning thereof. After this time period has lapsed, the conveyor 32 may be operated in order to extract from the cleaning unit 31 the cleaned elements 25 and bring them back into the purification chamber 23.

Cyclical operation of this cleaning system ensures that there is a layer of cleaning elements 25 which is always sufficiently clean for them to be crossed by the air which thus releases in an efficient manner the overspray onto the elements.

The downwards movement of the cleaning elements directed towards the discharge outlet and the introduction from above of the cleaned elements ensures that there is always a suitable quantity of sufficiently cleaned elements in the zone exposed to the air stream between the air inlet and outlet.

The movement of the cleaning elements moreover prevents them from sticking to each other because of the paint and prevents the passages between the elements in contact with each other from being obstructed by an excessive accumulation of paint. The overspray removal unit 17 may be operated (for example by a suitable electronic control unit known per se) to perform the removal, cleaning and re-introduction of the cleaning elements into the air stream at suitable intervals. These intervals may, for example, occur at suitable times and have fixed durations, predefined depending on the programmed operation of the booth, or may also be determined depending on the quantity of overspray produced or to be removed (based on the amount of paint sprayed inside the booth) or depending on the soiling of the cleaning elements 25.

In order to establish when the soiling of the cleaning elements requires activation of a cleaning cycle, an optical system may for example be provided, said system detecting the quantity of paint on the elements inside the purification chamber (for example depending on the change in colour or the increase in dimensions of the elements covered with paint) or a weighing system (for example with load cells) which control the cleaning cycle depending on the increase in weight of the elements inside the chamber (and therefore the increase in weight of the chamber itself) due to the accumulation of the paint on the cleaning elements.

FIG. 5 shows a first embodiment of the cleaning unit 31.

In this embodiment, the cleaning unit 31 comprises a tank 31a which will be filled with suitable cleaning liquid 34. The cleaning liquid may be a solvent suitable for the paint to be cleaned from the elements 25.

The tank 31a may also be designed as an ultrasonic cleaning tank with a suitable ultrasound emitter 35. In the case of ultrasonic cleaning, the cleaning liquid 34 may also be simply water, with the possible addition of additives for assisting the cleaning action. The ultrasonic system may be aided by suitable mechanical stirring systems and/or by means of suitable chemical attack.

The use of water ensures a lower degree of environmental impact and less difficulty for disposal.

Advantageously, the conveyor is designed to extract the cleaned elements 25 from the cleaning tank 31a without removing from the tank 31a significant amounts of cleaning liquid. For example, the helical screw may be suitably perforated so as to drain the liquid as it raises the elements 25 from the tank 31a.

In order to maintain for a long time and without interruptions the efficiency of the system for recirculating the cleaning elements, a known system 41 for replacing, topping up and/or purifying the liquid in the tank 31a may also be provided. The system 41 may for example comprise a hydraulic circuit for removing the polluted liquid from the tank and introducing it into the fresh liquid tank. This allows the level of cleaning efficiency of the elements inside the tank to be kept high.

The contaminated liquid may be accumulated and then disposed of or may also be treated and purified (for example by means of filtering) so that it can be reintroduced into the tank, if necessary with the addition also of fresh liquid taken from a suitable source or tank. This allows a reduction in the quantity of fresh liquid to be used and also a reduction in the quantity of waste liquid to be disposed of.

If necessary, operation of the conveyor 32 in a direction opposite to the direction of extraction of the elements outside of the cleaning tank may allow mixing of the liquid and the cleaning elements 25 inside the tank in order to obtain a more effective cleaning action. Alternatively, a suitable stirring element (for example a motorized propeller) may be used to stir the liquid continuously or at intervals. If preferred or necessary, the liquid inside the tank may on the contrary be kept stationary so as to deposit on the bottom of the tank the paint removed from the cleaning elements inside the tank.

FIG. 6 shows a second embodiment of the cleaning unit 31. In this second embodiment, the cleaning unit 31 comprises a drying stage 31b and a stirring stage 31c for drying and separating the paint present on the cleaning elements 25 discharged from the purification chamber 23.

The drying stage 31b is formed by a drying chamber inside which there is maintained a temperature suitable for drying the paint on the cleaning elements 25 in a time considered useful for recycling them in the plant. The temperature is chosen for example depending on the maximum time which is to be obtained for the time spent by the cleaning elements 25 inside the chamber of the drying stage 31b. For example, this temperature may be between 80° C. and 200° C. The time spent inside the chamber will also depend on the temperature chosen and may be for example between about 15 and about 45 minutes.

Obviously, the higher the temperature, the less may be the time spent therein. On the other hand, if a lower temperature is preferred, it is possible to increase the time spent by the elements inside the drying chamber.

Heating of the chamber may be performed for example by means of a known heating chamber 42 associated with the drying unit 31b. Said heating unit may for example be of the electric type or fuel (for example gas) gas type. The heating unit 42 may also be formed by a unit already provided for heating other parts of the plant to which the station 10 belongs.

For example, the residual heat of known treatment ovens normally present along painting lines may be used. Said residual heat may be obtained from the hot air exiting these ovens and suitably conveyed into the chamber of the drying unit 31b via the conveying ducts.

The temperature to be maintained inside the drying unit 31b may also be chosen for example so as to favour energy savings and/or to satisfy the usage requirement for the heat already present in the plant.

Drying of the paint on the cleaning elements 25 is understood as meaning hardening of the paint considered suitable or sufficient to cause the subsequent separation of the paint from the cleaning elements during the subsequent stirring stage 31c. The separation may also not be total, but that considered to be sufficient for the cleaning elements to be used again inside the purification chamber 23.

If necessary, a sufficient high circulation of air at room temperature across the drying chamber for a sufficiently long period of time may produce suitable drying of the paint.

Drying method, time and temperature may also depend on the type of paint used, as may be easily imagined by the person skilled in the art with the explanation given here.

After the treatment inside the chamber 31b the cleaning elements 25 pass into the following mixing stage 31c. This passage may be performed by means of transfer means 44 which may be for example also a simple controlled gate suitable arranged so as to transfer by means of gravity the elements 25 from the stage 31b to the stage 31c. Alternatively, transfer means 44 may also be provided and realized by a known conveyor system (for example of the belt, auger or other type).

The stirring stage 31c keeps the cleaning elements 25 in movement so as to cause separation of the dry paint present on them. The time spent by the cleaning elements 25 inside the stirring stage 31c will be established so as to obtain sufficient surface cleaning of the cleaning elements 25. To ensure a good surface cleaning action it is preferable that the cleaning elements should not have surface concavities or sharp edges. A preferable form for these elements in the case of a cleaning unit with drying and mixing was found to be the spherical or spheroidal form.

The stirring stage 31C may be realized with a motorized rotating container, for example able to rotate about a horizontal or inclined motorized axis 43, so as to produce suitable rubbing together of the cleaning elements such as to eliminate or reduce the paint on them to an amount considered to be sufficient for them to be used again inside the purification chamber 23. The rotating container may be preferably cylindrical or tapered at one or both the ends and also comprise, if necessary, internal vanes for assisting stirring with an action suitable for causing separation of the paint by means of friction, as may now be easily imagined by the person skilled in the art.

After the separation step has been performed in the stirring stage 31c, the cleaning elements 25 are discharged (for example across a further controlled gate or transfer means 41) into the pick-up zone of the conveyor 32 which brings them back into the purification chamber 23 in order to start the cycle again.

In a manner similar to that of the preceding embodiment, the entire cycle may be automatically controlled such that periodically the cleaning elements 25 are extracted from the purification chamber 23 and transported into the drying stage and then into the stirring stage for the programmed cleaning time and then transported by the conveyor 32 back into the purification chamber.

Although the drying and cleaning stages have been shown separate, such that advantageously the respective drying and paint separation cycles may be performed in parallel (for example so as to optimize the time necessary for cleaning of the cleaning elements 25), these drying and cleaning stages may also be incorporated in a single device, for example with drying which occurs directly inside the mixing chamber. Drying may also be performed during transportation of the elements 25 across the cleaning unit 31, for example with a hot air dryer which is combined with a transporting line which keeps the cleaning elements in movement from the inlet to the outlet of the cleaning unit.

The system for transporting or containing the cleaning elements may also be realized so as to allow the transportation of these cleaning elements, but not the dry flakes of paint, so as to perform separation of the flakes and their disposal from the plant.

At this point it is clear how the predefined objects have been achieved. The use of a mass of cleaning elements according to the invention ensures satisfactory removal of the overspray, while at the same time keeping the complexity of the removal plant to a minimum. Moreover, cleaning of the cleaning elements is performed without having to extract them from the plant and the cyclical movement of the elements inside the cleaning group or unit prevents them from sticking to each other owing to the paint retained by them. The possibility of performing cyclical cleaning also at close intervals ensures that the amount of paint on the cleaning elements may kept relatively small, while the efficiency of the overspray removal system remains high and substantially constant and cleaning of the cleaning elements is also facilitated with the use of a small amount of energy and/or cleaning liquid.

The cycles may also be continuous or substantially continuous, also with continuous discharging and recirculation of the cleaning elements. With very frequent cycles or with continuous recirculation, the quantity of overspray to which the elements are exposed during passage inside the chamber 23 may be very limited and therefore the time spent by the elements inside the cleaning unit 31 may be reduced.

The cleaning tank or the drying and stirring units may also be designed with dimensions such that there is a relatively long travel path for the cleaning elements between the entry zone and the exit zone, so that there is a suitable time for cleaning also with a substantially continuous movement of the elements between the inlet and outlet of the unit or parts of the cleaning unit. The movement between the inlet and outlet may also be facilitated by a suitable motorized movement system.

With the system according to the invention it is possible moreover to obtain a booth without maintenance stoppages or with limited and short maintenance downtime, since the overspray removal system may operate continuously, owing to the fact that it allows gradual replacement and cleaning in a closed cycle of the elements in the mass.

Owing to the fact that drying of the paint may also be avoided with the liquid system or on the contrary cleaning may be performed obtaining only dry paint flakes with drying and stirring, cleaning may be more rapid and efficient and less damaging for the environment and requires use of a smaller amount of energy.

By carrying out cleaning with an ultrasonic tank it is not necessary for the cleaning elements to have a shape without convexities or surface roughness, as is instead preferably with cleaning by means of mechanical friction. In this case it is possible to provide the cleaning elements with a preferred shape and, if desired, to use shapes suitable for example for increasing the surface area exposed to the paint (for example with superficial concavities) compared to the volume of each element, therefore increasing in the mass of cleaning elements the capacity for collecting the paint.

The cleaning cycle is moreover faster and more reliable also with mechanical cleaning and does not produce in any case in the open air dangerous flakes of dried paint which remain contained within closed zones of the cleaning plant and may be continuously or periodically removed for example even only by means of gravity from the stirring unit through a suitable perforated wall of this unit which allows the removed flakes to pass through to a suitable storage container (for example also located underneath the mixing unit 31c, as shown by way of example in FIG. 6 with a storage container indicated by 46), while retaining the cleaning elements. In this way it is also possible to establish the dimensions of the flakes which are extracted from the plant (so as to obtain even for example a dry paint powder, which is some cases is less dangerous than flakes). In fact, by suitably defining the dimensions of the through-holes in the wall it is possible to ensure that, until the flakes reach, owing to the continuous stirring together with the cleaning elements, the desired size, they remain within the stirring unit.

It is also possible to realize the conveyor 32 (for example as a perforated auger) so that it is able to transport only the cleaning elements and does not manage to raise or in any case causes the paint flakes to fall back down and does not transport them to the top of the purification chamber. A suitable air stream may also be provided flowing in the opposite direction to the conveyor 32 so as to prevent the conveyor from accidentally transporting paint flakes.

Obviously, the above description of embodiments applying the innovative principles of the present invention is provided by way of example of these innovative principles and must therefore not be regarded as limiting the scope of the rights claimed herein. For example, the booth may be different from that shown or several cleaning units 17 may be wholly or partly used for the same booth to treat large air flows, depending also on the dimensions of the booth and the quantity of overspray produced by it. The removal unit 17 may also extend longitudinally underneath the painting booth so that it covers all or most of the length of the booth.

A removal unit 17 with a cross-section similar to that shown in the figures may be easily realized with any desired longitudinal extension.

A longitudinally extending removal unit 17 may also comprise several outlet ducts for the clean air and several conveyors 33 distributed along the length of the tank 31.

A plant according to the invention may also comprise a plurality of removal units 17 arranged at intervals along the length of the booth and connected for example to the same intermediate chamber 19, if present.

Although the helical screw conveyor has been found to be particularly advantageous for raising the cleaned elements from the cleaning tank, other types of conveyor may also be used. For example, a known basket conveyor or the like may be used.

The booth and/or the plant may also comprise other known parts, not shown here and not forming the subject of the invention, for example for conditioning or filtering the air entering the booth, transport systems and additional painting devices, etc.

1. A painting plant, comprising:
a painting booth in which paint is sprayed and which is crossed by an air stream for evacuation of overspray from the painting booth, wherein the air stream exiting the painting booth passes through at least one overspray removal unit configured to remove the overspray from the air stream;
wherein the at least one overspray removal unit comprises a purification chamber containing a loose mass of cleaning elements, wherein the purification chamber has an inlet for the air stream with the overspray and an outlet for the air stream after the air stream has passed through at least part of the cleaning elements so as to release the overspray on the cleaning elements,
wherein the purification chamber comprises a discharge outlet configured to discharge cleaning elements present in the purification chamber,
wherein the discharge outlet is connected to a cleaning unit configured to clean the cleaning elements discharged through the discharge outlet, and
wherein between the cleaning unit and the purification chamber, there is a conveyor configured to transport cleaning elements from the cleaning unit back to the purification chamber.

2. The painting plant of claim 1, wherein the discharge outlet is equipped with a controlled shutter configured to discharge a predetermined quantity of the cleaning elements from the purification chamber at each actuation.

3. The painting plant of claim 1, wherein the discharge outlet is equipped with a partitioning shutter configured to discharge a predetermined quantity of the cleaning elements from the purification chamber at each actuation, and
wherein the partitioning shutter comprises a rotating cylindrical shutter with a pick-up sector.

4. The painting plant of claim 1, wherein the conveyor comprises a helical screw conveyor with an inlet end inside the cleaning unit and an outlet end close to a top of the purification chamber for discharging into the purification chamber.

5. The painting plant of claim 1, wherein the outlet for the air stream comprises a perforated wall configured to retain the cleaning elements in the purification chamber, and
wherein the perforated wall is configured to move between an operating position on the outlet for the air stream and a cleaning position extracted from the purification chamber.

6. The painting plant of claim 5, wherein cleaning devices configured to clean the perforated wall are present in the cleaning position.

7. The painting plant of claim 5, wherein the perforated wall is configured to rotate between the operating position and the cleaning position.

8. The painting plant of claim 5, wherein a second wall is configured to move with the perforated wall so as to be positioned on the outlet for the air stream in place of the perforated wall when the perforated wall is in the cleaning position, and
wherein the second wall is perforated so as to allow passage of the air stream or is not perforated so as to interrupt the passage of the air stream.

9. The painting plant of claim 1, wherein filters are present downstream of the outlet for the air stream.

10. The painting plant of claim 1, wherein the cleaning unit comprises a tank containing a liquid for cleaning the cleaning elements.

11. The painting plant of claim 10, wherein the tank is an ultrasonic cleaning tank.

12. The painting plant of claim 10, wherein the tank is connected to a liquid circulation system for replacement, topping-up, and/or purification of the liquid present in the tank.

13. The painting plant of claim 1, wherein the cleaning elements:
have a size greater than or equal to 1 millimeter (mm) and less than or equal to 50 mm;
have a spheroidal or spherical shape; and/or
are made of glass, ceramic, metal, plastic, or a combination of two or more thereof.

14. The painting plant of claim 1, wherein the purification chamber has the inlet for the air stream in an upper position, the discharge outlet in a lower position, and the outlet for the air stream at a height between the inlet for the air stream and the discharge outlet.

15. The painting plant of claim 1, wherein the purification chamber becomes narrower from a top of the purification chamber toward the discharge outlet.

16. The painting plant of claim 1, wherein the cleaning unit comprises:
a first stage configured to dry the overspray present on the cleaning elements discharged from the purification chamber to the cleaning unit; and
a second stage configured to separate the overspray present on the cleaning elements discharged from the purification chamber to the cleaning unit.

17. The painting plant of claim 16, wherein the second stage comprises a motorized container configured to rotate about a horizontal or inclined motorized axis.

18. The painting plant of claim 1, wherein the painting booth comprises a grilled floor for evacuating the air stream from the painting booth, and under which there is the at least one overspray removal unit connected to the outlet for the air stream through the grilled floor via an intermediate chamber configured to convey the air stream between the grilled floor and the at least one removal unit.

19. A painting plant, comprising:
a painting booth;
at least one overspray removal unit;
a cleaning unit; and
a conveyor;
wherein the painting plant is configured for spraying paint within the painting booth,
wherein the painting plant is further configured to be crossed by an air stream for evacuation of overspray from the painting booth,
wherein the painting plant is further configured so that the air stream, when exiting the painting booth, passes through the at least one overspray removal unit in order to remove the overspray from the air stream,
wherein the at least one overspray removal unit comprises a purification chamber configured to contain a loose mass of cleaning elements,
wherein the purification chamber comprises an inlet for the air stream with the overspray, an outlet for the air stream after the air stream has passed through at least part of the cleaning elements so as to release the overspray on the cleaning elements, and a discharge outlet,
wherein the discharge outlet is configured to discharge at least a portion of the cleaning elements from the purification chamber to the cleaning unit,
wherein the cleaning unit is configured to clean the cleaning elements discharged from the purification chamber to the cleaning unit, and
wherein the conveyor is configured to transport at least a portion of the cleaning elements from the cleaning unit back to the purification chamber.

20. A painting plant, comprising:
a painting booth;
at least one overspray removal unit;
a cleaning unit; and
a conveyor;
wherein the painting booth is configured for spraying paint within the painting booth,
wherein the painting booth is further configured so that an air stream enters the painting booth, entrains overspray, and then exits the painting booth to evacuate the overspray,
wherein the air stream, when exiting the painting booth, passes through the at least one overspray removal unit in order to remove the overspray from the air stream,
wherein the at least one overspray removal unit comprises a purification chamber configured to contain cleaning elements,
wherein the purification chamber comprises an inlet for the air stream with the overspray, an outlet for the air stream after the air stream has passed through at least part of the cleaning elements in the purification chamber, and a discharge outlet,
wherein the discharge outlet is configured to discharge a least a portion of the cleaning elements from the purification chamber to the cleaning unit,
wherein the cleaning unit is configured to clean the cleaning elements discharged from the purification chamber to the cleaning unit, and
wherein the conveyor is configured to transport at least a portion of the cleaning elements from the cleaning unit back to the purification chamber.
